(19) United States
(12) Patent Application Publication
(10) Pub. No.: US 2017/0111514 A1
(43) Pub. Date: Apr. 20, 2017

(54) FAILED COMMUNICATION EVENT

(71) Applicant: Microsoft Technology Licensing, LLC, Redmond, WA (US)

(72) Inventors: Vijay Chandrasekaran, Sunnyvale, CA (US); Nicholas Mark Cordrey, Redmond, WA (US)

(21) Appl. No.: 14/884,290

(22) Filed: Oct. 15, 2015

(51) Int. Cl. H04M 7/00; H04M 3/42

(52) U.S. Cl. CPC H04M 7/0084; H04M 3/42

(57) ABSTRACT

There is provided a user terminal comprising: at least one processor; and a memory comprising communication client application code for managing communications with at least one further user terminal over a first network, the code, when executed on the at least one processor, causes the user terminal to: send a call request to the at least one further user terminal over the first network; if a call has not been established with the at least one further user terminal after a predetermined period of time, determine why the call has not been established; select a notification to be displayed to a user of the user terminal in dependence on said determination; and cause said notification to be presented to the user

### BACKGROUND

Some communication systems allow the user of a device, such as a personal computer, to conduct voice or video calls over a packet-based computer network such as the Internet as well as conventional circuit switched networks such as GSM and PSTN communication networks. Such communication systems include voice or video over internet protocol (VoIP) systems. These VoIP systems are beneficial to the user as they are often of significantly lower cost to use than the conventional fixed line (PSTN) or mobile cellular (GSM) networks. This may particularly be the case for long-distance communication. To use a VoIP system, the user installs and executes client software on their device. The client software sets up the VoIP connections as well as providing other functions such as registration and authentication. In addition to voice communication, the client may also set up connections for other communication media such as instant messaging (“IM”), SMS messaging, file transfer and voicemail.

With increasing mobile bandwidths, there is increasing interest in providing packet-based voice and video calls via client applications running on user terminals such as Internet-enabled mobile phones. These user terminals comprise network interfaces 224 such as short-range RF transceivers operating on one or more unlicensed bands for accessing the Internet via wireless access points (e.g. of Wi-Fi access points of WLAN networks), and/or cellular transceivers operating on one or more licensed bands for accessing the Internet via a packet-based service of a cellular network such as GPRS (General Packet Radio Service) or HSPA (High Speed Packet Access).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Embodiments of the present disclosure relate to management of communication events between first and second user terminals. In particular embodiments of the present disclosure relate to management of communication events using a communication client application (or communication client app). ‘Using’ a communication client application the user may dial a number to place an outgoing call. The call may be placed from the communication client app, or alternatively using the native communication client app. The communication client app in such embodiments subscribes to call and dial events. When a number is dialled, or called, the communication client app seeks to establish a call with a corresponding communication client app on another user terminal. If the call fails to be established within a predetermined amount of time, the communication client app may cause for a notification to be presented to a user of the user terminal indicating that the call has failed to be established. In an embodiment of the present disclosure, the communication client app may cause a notification to be presented to a user that presents the option of attempting to establish the call again, but via another network (e.g. by a circuit switched network instead of via a packet switched network). This communication client application may be coded such that this type of notification (i.e. the offer to re-attempt to establish the call via a different network) is only presented to the user when the communication client application determines that the reason why the call was not established via the first network did not result from the another user terminal purposefully rejecting the call.

According to various implementations, managing the communication events in such a manner may be significant, especially for user terminals with limitations with respect to network connectivity and processor power consumption. According to a first aspect there is provided a user terminal comprising: at least one processor; and a memory comprising communication client application code for managing communications with at least one further user terminal over a first network, the code, when executed on the at least one processor, causes the user terminal to: send a call request to the at least one further user terminal over the first network; if a call has not been established with the at least one further user terminal after a predetermined period of time, determine why the call has not been established; select a notification to be displayed to a user of the user terminal in dependence on said determination; and cause said notification to be presented to the user.

According to a second aspect, there is provided a method comprising: sending a call request to at least one further user terminal over the first network; if a call has not been established with the at least one further user terminal after a predetermined period of time, determining why the call has not been established; selecting a notification to be displayed to a user of the user terminal in dependence on said determination; and causing said notification to be presented to the user.

A computer program product comprising computer executable instructions, which when executed by a computer, cause the computer to perform the method of any of the method claims

### BRIEF DESCRIPTION OF THE DRAWINGS

For a better understanding of the present disclosure and to show how it may be put into effect, reference is now made by way of example to the accompanying drawings in which:

FIG. 1 is a schematic representation of a communication system;

FIG. 2 is a schematic block diagram of a mobile terminal;

FIG. 3 is an example flow diagram of a communication client component; and

FIG. 4 is an example of some of the events that may be caused to happen by an embodiment of the communication client.

### DETAILED DESCRIPTION

Embodiments of the present disclosure are described by way of example only.

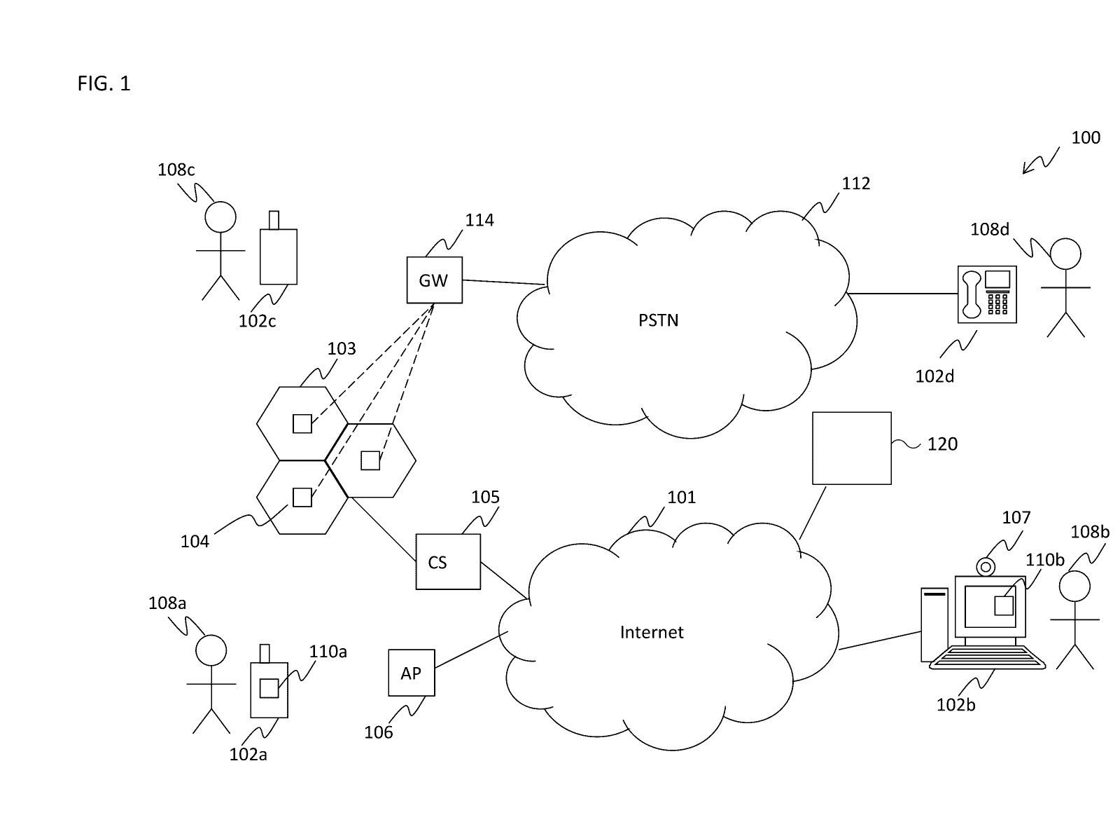

FIG. 1 is a schematic illustration of a communication system 100 comprising a packet-based network 101 such as the Internet, a mobile cellular network 103, and a circuit switched network 112 such as the public switched telephone network (PSTN). The mobile cellular network 103 comprises a plurality of base stations 104 (sometimes referred to as node Bs in 3GPP terminology). Each base station 104 is arranged to serve a corresponding cell of the cellular network 103. Each base station 104 is connected to the circuit switched network 112 via a gateway 114. Further, the packet-switched network 101 comprises a plurality of wireless access points 106 such as Wi-Fi access points for accessing the Internet. These may be the access points of one or more wireless local area networks (WLANs).

A plurality of user terminals 102 are arranged to communicate over one or more of the networks 101,103,112. For merely illustration purposes only, FIG. 1 shows user terminal 102a as an Internet-enabled mobile device, user terminal 102b as a desktop or laptop PC, user terminal 102c as a cellular mobile phone 102c, and user terminal 102d as a landline telephone connected to the circuit switched network 112.

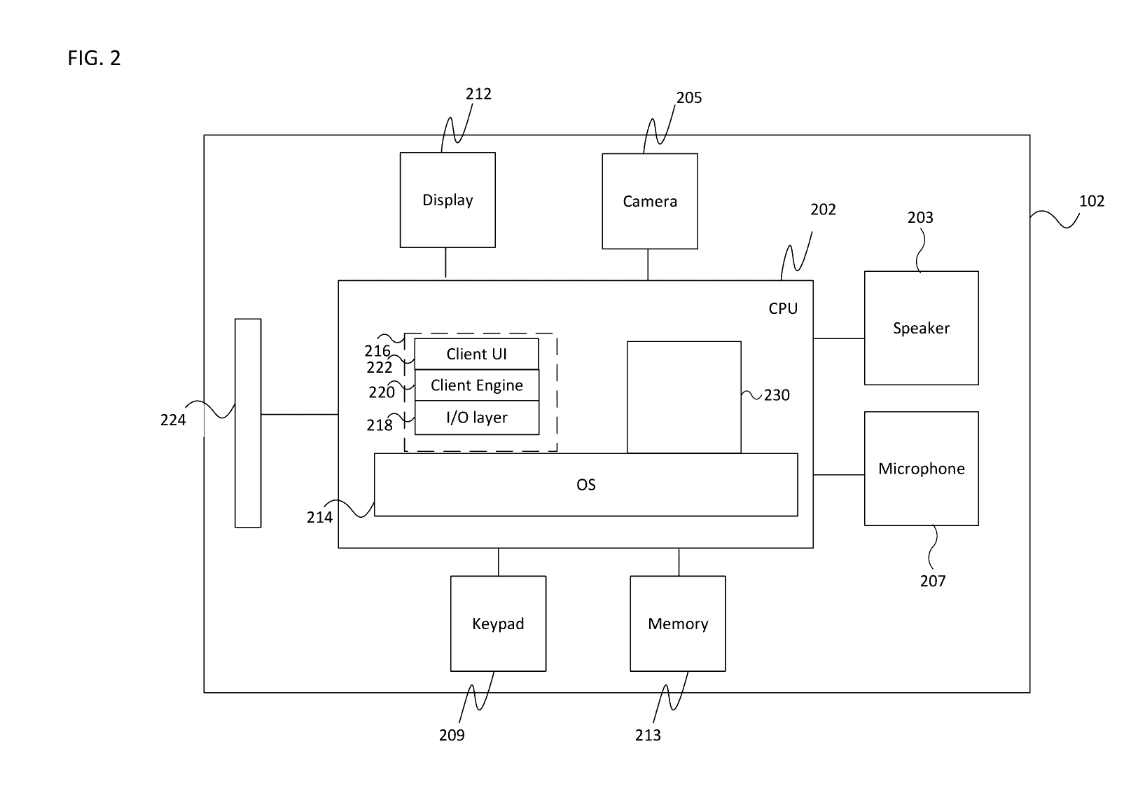

An example user terminal 102a is shown schematically in FIG. 2. The user terminal 102a may be one of an Internet-enabled mobile telephone; a handheld game console; a personal digital assistant (PDA); a tablet computer; or a laptop computer.

The user terminal 102a comprises a processing apparatus in the form of one or more processor units (CPUs) 202 coupled to a memory 213 storing a communication client application (or communication client app). The processor 202 is also coupled to: a microphone 207, a speaker 203, camera 205, one or more network interfaces 224, a keypad 209, and a display 212.

In the example shown in FIG. 2, the microphone 207, speaker 203, camera 205, keypad 209, and display 212 are examples of suitable user interface inputs and outputs. In some embodiments the user interface input may be a keyboard, mouse, pointing device, touchpad or any suitable user interface input device, for example gesture or motion control user input, head-tracking or eye-tracking user input, a ‘touch’ or ‘proximity’ detecting input configured to determine the proximity of the user to the display 212 (in other words a touch or hover touch interface).

The one or more network interfaces 224 enable the user terminal 102a to access the one or more networks 101,103,112. For example, user terminal 102a may comprise a cellular wireless transceiver for accessing the mobile cellular network 103 via the base stations 104, and/or a wired or wireless modem for accessing the Internet 101. In the case of a wireless modem, this typically comprises a short-range wireless transceiver (e.g. Wi-Fi) for accessing the Internet 101 via the wireless access points 106.

Access to the Internet 101 may also be achieved by other means such as GPRS (General Packet Radio Service) or HSPA (High Speed Packet Access). At a higher level of the cellular hierarchy, the cellular network 103 comprises a plurality of cellular controller stations 105 each coupled to a plurality of the base stations 104. The controller stations 105 are coupled to a traditional circuit-switched portion of the mobile cellular network 103 but also to the Internet 101. The controller stations 105 are thus arranged to allow access to packet-based communications via the base stations 104, including access to the Internet 101. The controller stations 105 may be referred to for example as Base Station Controllers (BSCs) in GSM/EDGE terminology or Radio Network Controllers (RNCs) in USTM or HSPA terminology.

The memory 213 may comprise a non-volatile memory such as an electronic erasable and programmable memory (EEPROM, or “flash” memory) coupled to the processor 202. The memory stores communications code arranged to be executed on the processor, and configured so as when executed to engage in communications over one or more networks 101,103,112. In at least some implementations, the communications code comprises a communication client application 110a provided by a software provider associated with the communication system. The communication client application 110a may be executed for performing communications such as voice or video calls with other user terminals 102 over the Internet 101, via a network interface 224 and wireless access points 106, and/or via the network interface 224, base stations 104 and controller stations 105 of the cellular network 103 as discussed above. However, one or more of the user terminals 102 involved could alternatively communicate via the network interface 224 and a wired modem, e.g. in the case of a call between a mobile terminal and a desktop PC

The CPU 202 is connected to the network interface 224 such as a modem for communication with the communication networks. The network interface 224 may be integrated into the user terminal 102 as shown in FIG. 2. In alternative user terminals the network interface 224 is not integrated into the user terminal 102. The network interface 224 may comprise a short-range wireless transceiver for communication to the wireless access points or a cellular transceiver for communication to the base stations.

As shown in FIG. 1 both user terminals 102a and 102b execute communication client application software 110 in order for the user terminals 102a and 102b to transmit and receive data over the Internet 101. In other words the communication client application may be used to initiate packet based communication with another communication client application associated with the same communication network (for example an overlay network and distinct from the communication system 100). The communication client application may for example be configured to transmit and receive data associated with a defined communication protocol to define the ‘network. For example the communication client application may be configured to communicate with other communication client applications executed on further user terminals using a Voice over Internet Protocol (VoIP) protocol. It is understood that in some embodiments a user terminal comprises some other client communication software, for example client communication software able to communicate over only one of the communication networks. The communication client application 110 may be downloaded and installed from a remote server. Furthermore in some embodiments the communication client application 110 when first installed or executed may be configured to contact and register the installation or execution of the communication client application at a communication client application database. The communication client application database may comprise parts which are locally cached on the user terminal 102, or remote from the user terminal (for example on a server or over a distributed computing system).

FIG. 2 also illustrates an operating system (“OS”) 214 executed on the CPU 202. Running on top of the OS 214 is a software stack 216 for the communication client application (CCA) 110a. The software stack shows a client protocol layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the device 102a and handles the transmission and receipt of data via the network interface 207. The client protocol layer 218 of the communication client app communicates with the operating system 214 and manages the connections over the communication system. Processes requiring higher level processing are passed to the client engine layer 220. The client engine 220 also communicates with the client user interface layer 222. The client engine 220 may be arranged to control the client user interface layer 222 to present information to the user 108a via the user interface of the client and to receive information from the user 108a via the user interface.

Also shown in FIG. 2 is a further communication client application 230. The further communication client may be a native communication client (the communication client provided with the device from the factory. The further communication client may thus be executed for performing communications such as voice or video calls with other user terminals 102 over the network interface 224, base stations 104 and controller stations 105 of the cellular network 103 as discussed above.

The following examples describe the use of a communication client application 110 in order to control the setting up of a call, following an inputted instruction from the user of the user terminal to call another user/user terminal

Although the communication client application may be able to make or place a call using the communication client application, there may be situations where this is not possible. For example where the other user terminal is not equipped with the communication client application and is only equipped with the native communication client or with another communication client, then the communication client application may be required to hand off the call making process to the native communication client or another communication client.

The following disclosure relates to the case in which a user terminal comprising the communication client application is unable to establish a call with another user terminal (for whatever reason). To address this, the user terminal waits a predetermined time after sending a call request to the another user terminal (i.e. a request to establish a call) and, if the call is not established within this predetermined time, automatically offers the user of the user terminal the option to try to establish the call via another network. In particular, to try to establish the call via another type of network (e.g. via a cellular network, such as the PSTN, instead of via the internet). This automatic offering is performed within the communication client application environment, via a notification presented to the user.

To save needless attempts to try to establish this call via another network, the communication client application acts to determine whether the user of the another user terminal (“the another user”) has purposefully rejected the initial call request. Examples of purposeful rejection of the call by the another user terminal include: if the another user terminal is configured to automatically reject all calls; and/or if the another user terminal is configured to automatically reject calls originating from, specifically, the user of the user terminal; and/or if the another user has manually (e.g. via a user input associated with the another user terminal) rejected the call request on receipt of the request, following the presentation of the request by the another user terminal to the user. If it is determined that the another user purposefully rejected the call request, the user terminal does not automatically offer the user of the user terminal the option to try to establish the call via another network.

In the following disclosure, there is discussed a user terminal comprising: at least one processor; and a memory comprising communication client application code for managing communications with at least one further user terminal over a first network. The code, when executed on the at least one processor, causes the user terminal to send a call request to the at least one further user terminal over the first network, and if a call has not been established with the at least one further user terminal after a predetermined period of time: determine why the call has not been established; select a notification to be displayed to a user of the user terminal in dependence on said determination; and cause said notification to be presented to the user.

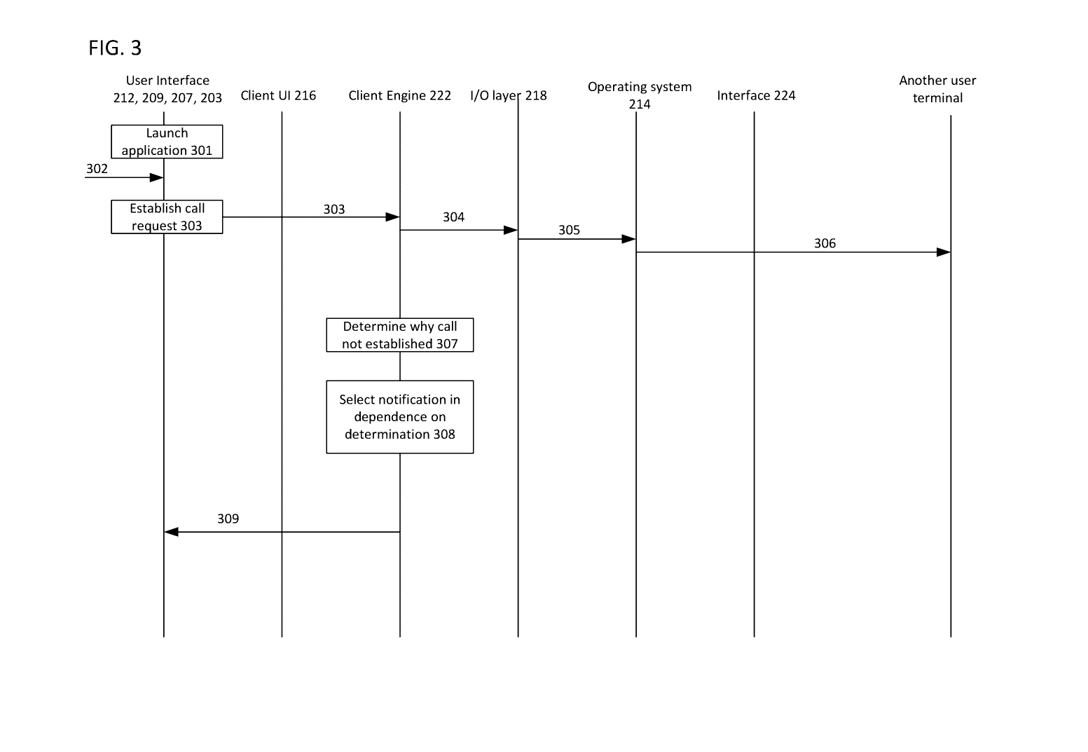

An example of how this user terminal may function is illustrated with respect to FIG. 3. FIG. 3 is a flow diagram illustrative of a user terminal comprising a communication client component.

In an initial action 301, the user terminal comprising communication client application code receives an input from a user that launches the communication client application. On this launch, the communication client application presents an interface to the user for requesting that a call be established with another user terminal The another user terminal may or may not have compatible communication client application code (i.e. communication client application that can communicate with the communication client application code resident on the user's user terminal).

At step 302, the user uses the interface of the user terminal to indicate another user to whom they would like to establish a call (such as a video and/or audio call). This may be indicated by the user entering a phone number or by selecting another user's name in, for example, an electronic contacts directory resident on the user terminal The another user has an associated user terminal and an address/identifier by which they may be contacted through the communication client application.

At step 303, the client UI 216 receives this indication and passes it to the client engine 220 for establishing a call. At step 304, the client engine 220 passes the request to I/O layer 218, for subsequently passing it to OS 214 in step 305. The OS then causes the network interface 224 to be available for transmission of a request for call establishment passed down from the client communication application 216. It is understood that, depending on the particular operation of the communication client application, other actions may be performed before a call request is transmitted. For example, the communication client application (e.g., the client engine 220 part) may check to determine if the dialled number/another user terminal is flagged as a communication client user. This may be checked against a remote database, if querying for the first time, or against a local cache. If the another user terminal is not a communication client user, the call request may not be transmitted. Alternatively, the call request may be transmitted with an accompanying invitation to download the communication client application.

The request is then transmitted in step 306 to the another user terminal The request is transmitted over a data packet switched network 101, which may be accessed via at least one of access point 106 and cellular network 103.

After a predetermined amount of time, if no call has been established following the transmission of the call request, the communication client application 216 is configured to determine why no call has been established at step 307. This may be performed by client engine 220.

The predetermined time may be set by a user or be a set pre-programmed value set by the programmers of the communication client application. The lapse of the predetermined time is measured from transmission of the establishment request at step 306. A possible way of measuring the time elapsed since the transmission at step 306 is to set a countdown timer that counts down from the pre-arranged value. The predetermined time may be measured from the time the message is actually transmitted via the network interface 224, or at any of steps 304 and 305 mentioned above. In an embodiment, the predetermined time may be 15 seconds. However, any value may be suitably selected for the predetermined time, such as 5 seconds, 8 seconds, etc. The predetermined time is set by the communication client application. The predetermined time may be set following an input provided by the user. The predetermined time may be set by the owner of the communication client application software.

There are multiple reasons why the call to the another user terminal might have failed to setup/establish. For example, there may be a problem with the network (e.g. a failed router, bottlenecking of transmissions, etc.) or the like that prevents the another user terminal from receiving the session request. The another user terminal may receive the request but be unable to respond to it (for example, if the processor of the another user terminal is engaged in a resource intensive task, or if the another user terminal does not receive a user input accepting the call in time). The another user of the another user terminal may be presented with an indication of an incoming call but have previously indicated that they would not like to receive any calls. The another user terminal may be configured (e.g. through a setting entered by a user) that call requests originating from the user (either in particular or as part of a wider group of users) be refused as a matter of course. In other words, calls from the user terminal to the another user terminal may be blocked. In all of these cases, the call request will fail (i.e. no call would be established in respect of this request).

The determination may simply be a determination of whether or not the another user terminal purposefully rejected the call. For example, if the another user selected to decline the call using the another user terminal interface, this is an indication that the another user terminal purposefully rejected the call. Similarly, the another user terminal may be programmed (e.g. through a settings menu) to block calls originating from the (or indeed any) user. In this case, the another user terminal is again considered to have purposefully rejected the call.

The client engine may make the determination following the receipt of feedback from at least one of a network entity in the first network and the at least one further user terminal. The feedback may comprise an explicit indication as to why the call has not been established (e.g. by identifying a specific fault in the network). The feedback may comprise an implicit indication as to why the call has not been established (for example, the feedback may simply indicate that the call is to be disconnected). This latter indication may be used to determine that the another user purposefully declined the call.

When the communication client application receives an indication from the another user terminal that the another user terminal has purposefully rejected the call request, the client engine may choose to not take any action until the predetermined time has elapsed. In this case, the client UI 222 continues to present an indication to the user of the user terminal that the call request is still pending. The determination is then made at the predetermined time in accordance with the above. In the alternative, the client engine may be fitted with an override function, so that if a rejection indication is received from the another user terminal before expiry of the predetermined time, the client engine instructs the client UI 216 to cause a notification to be presented to the user that the call request has been terminated.

At step 308, the client engine 220 selects a notification in dependence on the determined reason why the call failed. For some determined reasons, the notification presents to a user the option of trying to establish the call via a second network. This offered option is presented automatically in response to the determination. In particular, the second network may be a circuit switched network (e.g. a cellular network/the PSTN). The first network may be a packet switched network (e.g. the internet). Even though the first and second networks are different, they may use the same or similar access points for accessing the different networks. For example, with reference to FIG. 1, the user terminal may access both the data packet switched network 101 and the circuit switched network (cellular network/PSTN 112) through access points 104 of the cellular network 103. However, the present disclosure is not limited to this case, as it may be that the different networks are accessed via different access points, such as access points 106 and 104 in FIG. 1.

For other determined reasons, the notification merely states that the call could not be established, and does not automatically offer the option of trying to establish the call via a circuit switched network. In an embodiment, the only notifications for which the circuit switched network option is not presented is when the another user/user terminal has responded to the call request with an indication that another user does not want to receive the call. In other words, when the another user has purposely rejected the call request, an option to attempt to establish the call by another network is not presented to the user.

The presented notification may comprise a primary contact number of the another user. The primary contact number may be the number used to initiate the call through the communication client application. The contact numbers used for initiating a call to the another user may be cached locally in the user terminal. If there are multiple contact numbers for the another user cached locally, the notification may list the multiple contact numbers for the another user. The multiple contact numbers may each be selectable by the user for initiating a phone call by the second network. At step 309, the client engine passes the selected notification to the client UI 216, which causes a user interface to present this notification to the user of the user terminal. The selected notification may (if it is of the type that automatically offers the user the opportunity to attempt to establish the call with another user via the second network) comprise a link through. Activation of the link through by the user via a user interface of the user terminal causes the communication client to cause a call connection request to be sent over the second network. In essence, such a notification may be considered to be a one-click connection request for attempting to establish a call over the second network.

At step 310, a user interface may receive an input from the user in response to the displayed notification. For example, where the option is automatically presented to attempt to establish this call via the second network, the user interface may receive an input indicative that the user would like to establish the call via the second network. In response to this, the communication client may utilise the operating system to cause a new call request to be transmitted to the another user via the second network. The input may alternatively indicate that some other action should take place. For example, the input may indicate that the communication client application should exit, that a different call should be made (i.e. to another (third) user terminal), and/or that to perform other actions within the communication application environment.

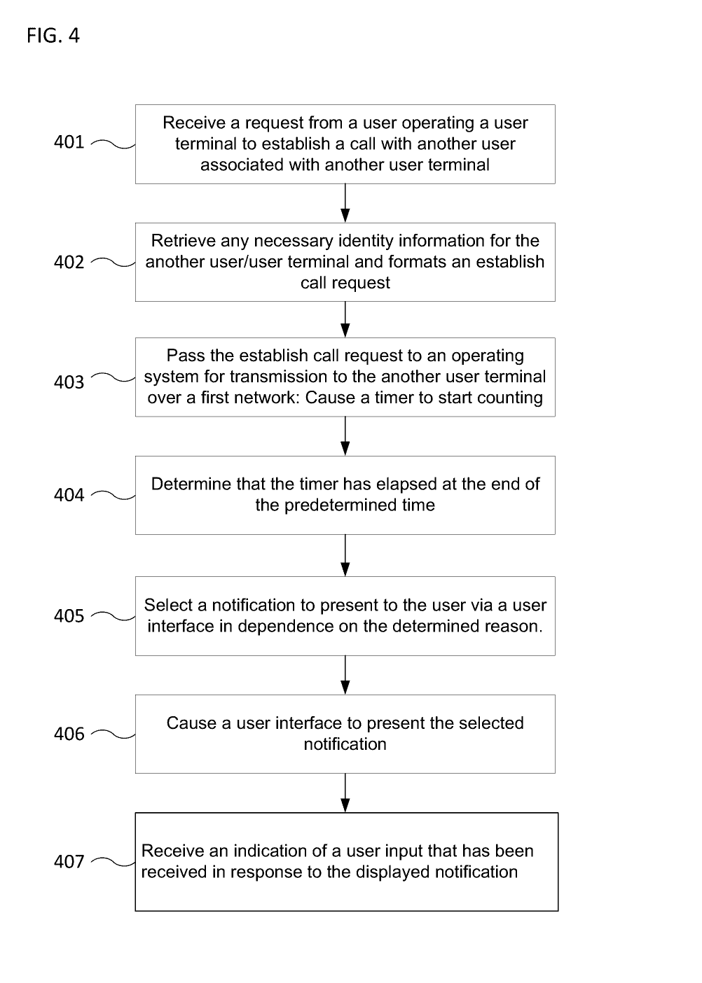

A flow chart of possible actions taken only by the communication client is illustrated with respect to FIG. 4.

At 401, the communication client receives a request from a user operating a user terminal to establish a call with another user associated with another user terminal

At 402, the communication client retrieves any necessary identity information for the another user/user terminal and formats an establish call request.

At 403, the establish call request is passed to an operating system for transmission to the another user terminal over a first network. At the same time, a timer is caused to start counting. The timer is set to measure up to a predetermined amount of time defined by the communication client.

At 404, the communication client application determines that the timer has elapsed at the end of the predetermined time, provided a call has not been aborted by the user or accepted/answered by the another user in the predetermined time. If the call is aborted by the user or answered/accepted by the another user, steps 404 onwards are not performed for that call request.

At 405, the communication client determines a reason why the call request did not result in the establishment of a phone call. As mentioned above, this may comprise making a determination as to whether or not the another user terminal purposefully rejected the call request.

At 406, the communication client selects a notification to present to the user via a user interface. The selection is performed in dependence on the determined reason. At least one possible notification automatically offers the option for the user to attempt to establish the call via a second network (i.e. via a circuit switched network, when the first network is a packet switched network). This automatic option may be offered only when the communication client determines that the another user did not purposefully reject the call.

At 407, the communication client causes a user interface to present the selected notification to the user.

At 408, the communication client receives an indication of a user input that has been received in response to the displayed notification. When the notification offers the option for the user to attempt to establish the call via a second network, an indication of an affirmative response to this option input from the user results in the communication client causing a request for a call setup to be transmitted via the second network.

Where references have been made in the above to presenting notifications and/or indications to the user of the user terminal, this may be performed graphically (e.g. via a display/graphical user interface). The graphical representation may take a variety of different forms. For example, the notification may be presented textually in the current operating language of the user terminal and/or symbols representative of the intention may be presented. Alternatively, or in addition, this notification may be presented to a user using an audio output, such as a speaker.

In the above, references have been made to providing a call request over first and second networks (e.g. over packet switched and circuit switched networks). This language is intended to imply the main routing mechanism used for the call request, after receipt by the access point being used. In the more specific case, the first network may be considered the internet, while the second network may be considered a cellular network, such as the PSTN.

It is understood that any number of the above-mentioned aspects may be combined in a single embodiment without any loss of generality.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). Where a particular device is arranged to execute a series of actions as a result of program code being executed on a processor, these actions may be the result of the executing code activating at least one circuit or chip to undertake at least one of the actions via hardware. At least one of the actions may be executed in software only. The program code can be stored in one or more computer readable memory devices. The features of the techniques described below are platform-independent, meaning that the techniques may be implemented on a variety of commercial computing platforms having a variety of processors.

For example, the user terminals configured to operate as described above may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. A computer-readable storage medium does not include signals per se. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Therefore, according to a first aspect there is provided a user terminal comprising: at least one processor; and a memory comprising communication client application code for managing communications with at least one further user terminal over a first network, the code, when executed on the at least one processor, causes the user terminal to: send a call request to the at least one further user terminal over the first network; if a call has not been established with the at least one further user terminal after a predetermined period of time, determine why the call has not been established; select a notification to be displayed to a user of the user terminal in dependence on said determination; and cause said notification to be presented to the user.

Said notification may present an option for the call to be placed over a second network.

The code, when executed on the at least one processor, may further cause the user terminal to: receive an input from a user of the user terminal indicating that they would like to place a call over the second network; and cause a call request to be sent to the at least one further user terminal over the second network.

Said notification may only present an option for the call to be placed over a second network if the user terminal has not received an indication that a user of the at least one further user terminal has rejected the call request.

The code, when executed on the at least one processor, may further cause the user terminal to: receive an indication that a user of the at least one further user terminal has rejected the call request; and cause a notification to be presented to the user of the user terminal that indicates that the call request is still pending.

The code, when executed on the at least one processor, may further cause the user terminal to: receive feedback from at least one of a network entity in the first network and the at least one further user terminal; and use said feedback in said determination of why the call has not been established. Said feedback may comprise an explicit indication as to why the call has not been established. Said feedback may comprise an implicit indication as to why the call has not been established.

The code, when executed on the at least one processor, further causes the user terminal to: cause said notification to be presented to the user via a graphical user interface.

The first network may be a packet switched network and the second network is a circuit switched network.

According to a second aspect, there is provided a method comprising: sending a call request to at least one further user terminal over the first network; if a call has not been established with the at least one further user terminal after a predetermined period of time, determining why the call has not been established; selecting a notification to be displayed to a user of the user terminal in dependence on said determination; and causing said notification to be presented to the user.

Said notification may present an option for the call to be placed over a second network. The method may further comprise: receiving an input from a user of the user terminal indicating that they would like to place a call over the second network; and causing a call request to be sent to the at least one further user terminal over the second network.

Said notification presenting an option for the call to be placed over a second network may be only displayed if the user terminal has not received an indication that a user of the at least one further user terminal has rejected the call request.

The method may further comprise: receiving an indication that a user of the at least one further user terminal has rejected the call request; and causing a notification to be presented to the user of the user terminal that indicates that the call request is still pending.

The method may further comprise: receiving feedback from at least one of a network entity in the first network and the at least one further user terminal; and using said feedback in said determination of why the call has not been established. Said feedback may comprise an explicit indication as to why the call has not been established. Said feedback may comprise an implicit indication as to why the call has not been established.

The method may further comprise: causing said notification to be presented to the user via a graphical user interface.

According to a third aspect, there is provided a computer program product comprising computer executable instructions, which when executed by a computer, cause the computer to perform the method of any of claims 11 to 19.

1. A user terminal comprising:
at least one processor; and
a memory comprising communication client application code for managing communications with at least one further user terminal over a first network, the code, when executed on the at least one processor, causes the user terminal to:
send a call request to the at least one further user terminal over the first network;
if a call has not been established with the at least one further user terminal after a predetermined period of time,
determine why the call has not been established;
select a notification to be displayed to a user of the user terminal in dependence on said determination; and
cause said notification to be presented to the user.

2. A user terminal as claimed in claim 1, wherein said notification presents an option for the call to be placed over a second network.

3. A user terminal as claimed in claim 2, wherein the code, when executed on the at least one processor, further causes the user terminal to:
receive an input from a user of the user terminal indicating that they would like to place a call over the second network; and
cause a call request to be sent to the at least one further user terminal over the second network.

4. A user terminal as claimed in claim 2, wherein said notification presenting an option for the call to be placed over a second network is only displayed if the user terminal has not received an indication that a user of the at least one further user terminal has rejected the call request.

5. A user terminal as claimed in claim 1, wherein the code, when executed on the at least one processor, further causes the user terminal to:
receive an indication that a user of the at least one further user terminal has rejected the call request; and
cause a notification to be presented to the user of the user terminal that indicates that the call request is still pending.

6. A user terminal as claimed in claim 1 wherein the code, when executed on the at least one processor, further causes the user terminal to:
receive feedback from at least one of a network entity in the first network and the at least one further user terminal; and
use said feedback in said determination of why the call has not been established.

7. A user terminal as claimed in claim 6, wherein said feedback comprises an explicit indication as to why the call has not been established.

8. A user terminal as claimed in claim 6, wherein said feedback comprises an implicit indication as to why the call has not been established.

9. A user terminal as claimed in claim 1, wherein the code, when executed on the at least one processor, further causes the user terminal to:
cause said notification to be presented to the user via a graphical user interface.

10. A user terminal as claimed in claim 1, wherein the first network is a packet switched network and the second network is a circuit switched network.

11. A method comprising:
sending a call request to at least one further user terminal over the first network;
if a call has not been established with the at least one further user terminal after a predetermined period of time,
determining why the call has not been established;
selecting a notification to be displayed to a user of the user terminal in dependence on said determination; and
causing said notification to be presented to the user.

12. A method as claimed in claim 11, wherein said notification presents an option for the call to be placed over a second network.

13. A method as claimed in claim 12, further comprising:
receiving an input from a user of the user terminal indicating that they would like to place a call over the second network; and
causing a call request to be sent to the at least one further user terminal over the second network.

14. A method as claimed in claim 12, wherein said notification presenting an option for the call to be placed over a second network is only displayed if the user terminal has not received an indication that a user of the at least one further user terminal has rejected the call request.

15. A method as claimed in claim 11, further comprising:
receiving an indication that a user of the at least one further user terminal has rejected the call request; and
causing a notification to be presented to the user of the user terminal that indicates that the call request is still pending.

16. A method as claimed in claim 11, further comprising:
receiving feedback from at least one of a network entity in the first network and the at least one further user terminal; and
using said feedback in said determination of why the call has not been established.

17. A method as claimed in claim 16, wherein said feedback comprises an explicit indication as to why the call has not been established.

18. A method as claimed in claim 16, wherein said feedback comprises an implicit indication as to why the call has not been established.

19. A method as claimed in claim 11, further comprising:
causing said notification to be presented to the user via a graphical user interface.

20. A computer program product comprising computer executable instructions, which when executed by a computer, cause the computer to perform the method of claim 11.
